(19) United States
(12) Patent Application Publication
(10) Pub. No.: US 2025/0327698 A1
(43) Pub. Date: Oct. 23, 2025

(54) CORIOLIS FLOWMETER WITH DETECTION OF AN EXTERNAL MAGNET FIELD

(71) Applicant: MICRO MOTION, INC., Boulder, CO (US)

(72) Inventors: Gregory Treat LANHAM, Longmont, CO (US); Anthony William PANKRATZ, Arvada, CO (US); Adam RECKSIEDLER, Loveland, CO (US); Marcus J. SCHMIDT, Centennial, CO (US)

(73) Assignee: MICRO MOTION, INC., Boulder, CO (US)

(21) Appl. No.: 18/865,473

(22) PCT Filed: Jun. 7, 2022
(86) PCT No.: PCT/US2022/032520

§ 371 Date: Nov. 13, 2024

(51) Int. Cl. G01F 1/84

(52) U.S. Cl. CPC G01F 1/8436; G01F 1/8422; G01F 1/8427; G01F 1/8431; G01F 1/8477

(57) ABSTRACT

A Coriolis flowmeter (5) is provided, the Coriolis flowmeter (5) comprising flow conduits (103A, 103B), having a driver (104), and pick-off sensors (105, 105′) connected thereto. A meter electronics (20) is configured to drive the driver (104) to oscillate the flow conduits (103 A, 103B), and to receive signals from the pick-off sensors (105, 105′). The meter electronics (20) is configured to capture voltages for both the pick-off sensors (105, 105′) and determine a PO_{RATIO} and determine whether the PO_{RATIO} falls within a predetermined PO_{LIMIT}. The presence of an external magnetic field is indicated if the PO_{RATIO} falls outside the predetermined PO_{LIMIT}.

### TECHNICAL FIELD

The embodiments described below relate to vibratory sensors and, more particularly, to external magnetic field detection therefor.

### BACKGROUND

Vibrating sensors, such as for example, vibrating densitometers and Coriolis flowmeters are generally known, and are used to measure mass flow and other information related to materials flowing through a conduit in the flowmeter. Exemplary Coriolis flowmeters are disclosed in U.S. Pat. Nos. 4,109,524, 4,491,025, and Re. 31,450. These flowmeters have meter assemblies with one or more conduits of a straight or curved configuration. Each conduit configuration in a Coriolis mass flowmeter, for example, has a set of natural vibration modes, which may be of simple bending, torsional, or coupled type. Each conduit can be driven to oscillate at a preferred mode. When there is no flow through the flowmeter, a driving force applied to the conduit(s) causes all points along the conduit(s) to oscillate with identical phase or with a small “zero offset”, which is a time delay measured at zero flow.

As material begins to flow through the conduit(s), Coriolis forces cause each point along the conduit(s) to have a different phase. For example, the phase at the inlet end of the flowmeter lags the phase at the centralized driver position, while the phase at the outlet leads the phase at the centralized driver position. Pickoffs on the conduit(s) produce sinusoidal signals representative of the motion of the conduit(s). Signals output from the pickoffs are processed to determine the time delay between the pickoffs, which is known as the ΔT. The time delay between the two or more pickoffs is proportional to the mass flow rate of material flowing through the conduit(s).

A meter electronics connected to the driver generates a drive signal to operate the driver and also to determine a mass flow rate and/or other properties of a process material from signals received from the pickoffs. The driver may comprise one of many well-known arrangements; however, a magnet and an opposing drive coil have received great success in the flowmeter industry. An alternating current is passed to the drive coil for vibrating the conduit(s) at a desired conduit amplitude and frequency. It is also known in the art to provide the pickoffs as a magnet and coil arrangement very similar to the driver arrangement.

As flowtubes vibrate, pickoff bobbin wires pass through a magnetic field of a magnet, which generates a voltage. A major factor in generating such voltage is the radial magnetic field. If the magnetic field is disturbed or changes during the meter's operation, the meter's output will be affected. One way to disturb the magnetic field of the pickoffs is to place another magnet in close proximity to a pickoff magnet and/or coil. By placing an external magnet close to the pickoff of a Coriolis meter the flow reading can be changed either indicating more flow or less flow depending on the external magnet's pole orientation or the external magnet's location on the meter, with respect to the inlet or outlet pickoffs and/or the driver. Once the magnet is removed, the sensor voltages and phase shift return to normal. This ability to manipulate flow can and has been used to disadvantage an unknowing party in a flowmeter-measured transaction. What is needed is a device and method to detect external magnetic fields for a flowmeter.

### SUMMARY

A Coriolis flowmeter is provided according to an embodiment, comprising flow conduits and a driver and pick-off sensors connected to the flow conduits. A meter electronics is configured to drive the driver to oscillate the flow conduits, and to receive signals from the pick-off sensors. The meter electronics is configured to capture voltages for both the pick-off sensors and determine a PO_{RATIO} and determine whether the PO_{RATIO} falls within a predetermined PO_{LIMIT}. The meter electronics is configured to indicate a presence of an external magnetic field if the PO_{RATIO} falls outside the predetermined PO_{LIMIT}.

A method for operating a Coriolis flowmeter is provided according to an embodiment. The method comprises flowing a flow material through flow conduits of the flowmeter and driving a driver connected to the flow conduits to oscillate the flow conduits in a first bending mode. Signals are received from pick-off sensors connected to the flow conduits, and voltages are captured for the pick-off sensors and a PO_{RATIO} is determined. It is determined whether the PO_{RATIO} falls within a predetermined PO_{LIMIT}, and a presence of an external magnetic field is indicated if the PO_{RATIO} falls outside the predetermined PO_{LIMIT}.

### Aspects

According to an aspect, a Coriolis flowmeter comprises flow conduits and a driver and pick-off sensors connected to the flow conduits. A meter electronics is configured to drive the driver to oscillate the flow conduits, and to receive signals from the pick-off sensors. The meter electronics is configured to capture voltages for both the pick-off sensors and determine a PO_{RATIO} and determine whether the PO_{RATIO} falls within a predetermined PO_{LIMIT}. The meter electronics is configured to indicate a presence of an external magnetic field if the PO_{RATIO} falls outside the predetermined PO_{LIMIT}.

Preferably, a first process variable is collected and compared to a first confidence interval, wherein the meter electronics is configured to indicate a presence of an external magnetic field if the first process variable falls within the first confidence interval and the PO_{RATIO} falls outside a predetermined PO_{LIMIT}.

Preferably, a second process variable is collected and compared to a second confidence interval, wherein the meter electronics is configured to indicate a presence of an external magnetic field if both the first and second process variables fall within their respective confidence intervals and the PO_{RATIO} falls outside a predetermined PO_{LIMIT}.

Preferably, a third process variable is collected and compared to a third confidence interval, and wherein the meter electronics is configured to indicate a presence of an external magnetic field if the first, second and third process variables fall within their respective confidence intervals and the PO_{RATIO} falls outside a predetermined PO_{LIMIT}.

Preferably, the first, second, and third process variables each comprise one of a flow tube frequency, drive gain, fluid density, and damping factor.

Preferably, a PO_{ZERO} is collected by the meter electronics, and at least one of an average and standard deviation are determined for the PO_{ZERO} by the meter electronics, and the meter electronics is configured to determine the PO_{LIMIT} as comprising a permissible deviation from the PO_{ZERO}.

Preferably, the meter electronics returns a “transition” state if any of the first, second, and third process variables are outside their respective confidence intervals.

Preferably, the meter electronics returns a “normal” state if all of the first, second, and third process variables are within their respective confidence intervals and the PO_{RATIO} falls within the predetermined PO_{LIMIT}.

According to an aspect, a method for operating a Coriolis flowmeter comprises flowing a flow material through flow conduits of the flowmeter and driving a driver connected to the flow conduits to oscillate the flow conduits in a first bending mode. Signals are received from pick-off sensors connected to the flow conduits, and voltages are captured for the pick-off sensors and a PO_{RATIO} is determined. It is determined whether the PO_{RATIO} falls within a predetermined PO_{LIMIT}, and a presence of an external magnetic field is indicated if the PO_{RATIO} falls outside the predetermined PO_{LIMIT}.

Preferably, the method comprises collecting a first process variable, comparing the first process variable to a first confidence interval, and indicating a presence of an external magnetic field if the first process variable falls within the first confidence interval and the PO_{RATIO} falls outside a predetermined PO_{LIMIT}.

Preferably, the method comprises collecting a second process variable, comparing the second process variable to a second confidence interval, and indicating a presence of an external magnetic field if both the first and second process variables fall within their respective confidence intervals and the PO_{RATIO} falls outside a predetermined PO_{LIMIT}.

Preferably, the method comprises collecting a third process variable, comparing the third process variable to a third confidence interval, and indicating a presence of an external magnetic field if both the first and third process variables fall within their respective confidence intervals and the PO_{RATIO} falls outside a predetermined PO_{LIMIT}.

Preferably, the first, second, and third process variables each comprise one of a flow tube frequency, drive gain, fluid density, and damping factor.

Preferably, the method comprises collecting a PO_{ZERO}, determining at least one of an average and standard deviation for the PO_{ZERO}, and determining the PO_{LIMIT} that comprises a permissible deviation from the PO_{ZERO}.

Preferably, the method comprises returning a “transition” state if any of the first, second, and third process variables are outside their respective confidence intervals.

Preferably, the method comprises returning a “normal” state if all of the first, second, and third process variables are within their respective confidence intervals and the PO_{RATIO} falls within the predetermined PO_{LIMIT}.

### BRIEF DESCRIPTION OF THE DRAWINGS

The same reference number represents the same element on all drawings. It should be understood that the drawings are not necessarily to scale.

FIG. 1 shows a vibratory meter according to an embodiment;

FIG. 2 shows a meter electronics according to an embodiment;

FIG. 3 shows the effect of magnetic fields on a flowmeter sensor pickoff voltage according to an embodiment;

FIG. 4 shows the effect of magnetic fields on flow rate measurement according to an embodiment;

FIG. 5A illustrates the magnetic field of a pickoff assembly with no magnet present;

FIG. 5B illustrates the magnetic field of a pickoff assembly when an external magnet is present with the magnet's south pole oriented towards the pickoff assembly;

FIG. 5C illustrates the magnetic field of a pickoff assembly when an external magnet is present with the magnet's north pole oriented towards the pickoff assembly;

FIG. 6 illustrates a flow chart related to an example of an embodiment for magnetic tampering detection;

FIG. 7 illustrates a flow chart related to another example embodiment for magnetic tampering detection;

FIG. 8 illustrates pseudocode for a magnetic tampering embodiment; and

FIGS. 9A and 9B illustrate false flag detection for embodiments of the present invention.

### DETAILED DESCRIPTION

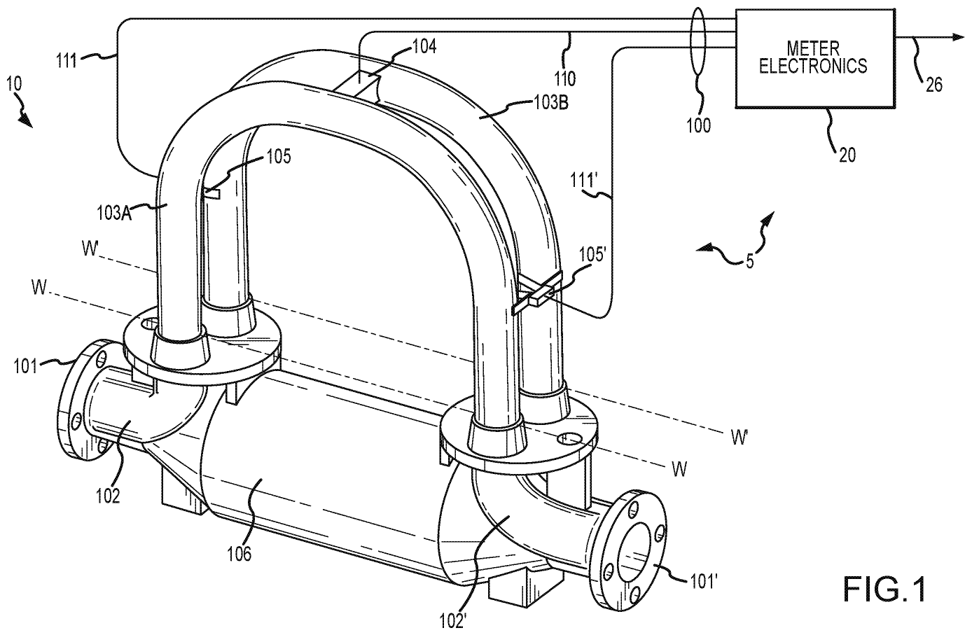

FIGS. 1-9B and the following description depict specific examples to teach those skilled in the art how to make and use the best mode of embodiments of a sensor assembly, brace bars, drivers, and pickoff sensors. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of embodiments. As a result, the embodiments described below are not limited to the specific examples described below, but only by the claims and their equivalents.

FIG. 1 shows a flowmeter 5 according to an embodiment. The flowmeter 5 comprises a sensor assembly 10 and meter electronics 20. The meter electronics 20 is connected to the sensor assembly 10 via leads 100 and is configured to provide measurements of one or more of a density, mass flow rate, volume flow rate, totalized mass flow, temperature, or other measurements or information over a communication path 26. The flowmeter 5 can comprise a Coriolis mass flowmeter or other vibratory flowmeter. It should be apparent to those skilled in the art that the flowmeter 5 can comprise any manner of flowmeter 5, regardless of the number of drivers, pick-off sensors, flow conduits, or the operating mode of vibration.

The sensor assembly 10 includes a pair of flanges 101 and 101′, manifolds 102 and 102′, a driver 104, pick-off sensors 105 and 105′, and flow conduits 103A and 103B. The driver 104 and the pick-off sensors 105 and 105′ are connected to the flow conduits 103A and 103B.

The flanges 101 and 101′ are affixed to the manifolds 102 and 102′. The manifolds 102 and 102′ can be affixed to opposite ends of a spacer 106 in some embodiments. The spacer 106 maintains the spacing between the manifolds 102 and 102′. When the sensor assembly 10 is inserted into a pipeline (not shown) which carries the process fluid being measured, the process fluid enters the sensor assembly 10 through the flange 101, passes through the inlet manifold 102 where the total amount of process fluid is directed to enter the flow conduits 103A and 103B, flows through the flow conduits 103A and 103B and back into the outlet manifold 102′, where it exits the sensor assembly 10 through the flange 101′.

The process fluid can comprise a liquid. The process fluid can comprise a gas. The process fluid can comprise a multi-phase fluid, such as a liquid including entrained gases and/or entrained solids, for example without limitation. The flow conduits 103A and 103B are selected and appropriately mounted to the inlet manifold 102 and to the outlet manifold 102′ so as to have substantially the same mass distribution, moments of inertia, and elastic moduli about the bending axes W-W and W′-W′, respectively. The flow conduits 103A and 103B extend outwardly from the manifolds 102 and 102′ in an essentially parallel fashion.

The flow conduits 103A and 103B are driven by the driver 104 in opposite directions about the respective bending axes W and W′ and at what is termed the first out of phase bending mode of the flowmeter 5. The driver 104 may comprise one of many well-known arrangements, such as a magnet mounted to the flow conduit 103A and an opposing coil mounted to the flow conduit 103B. An alternating current is passed through the opposing coil to cause both conduits to oscillate. A suitable drive signal is applied by the meter electronics 20 to the driver 104 via lead 110. Other driver devices are contemplated and are within the scope of the description and claims.

The meter electronics 20 receives sensor signals on leads 111 and 111′, respectively. The meter electronics 20 produces a drive signal on lead 110 which causes the driver 104 to oscillate the flow conduits 103A and 103B. Other sensor devices are contemplated and are within the scope of the description and claims.

The meter electronics 20 processes the left and right velocity signals from the pick-off sensors 105 and 105′ in order to compute a flow rate, among other things. The communication path 26 provides an input and an output means that allows the meter electronics 20 to interface with an operator or with other electronic systems. The description of FIG. 1 is provided merely as an example of the operation of a flowmeter and is not intended to limit the teaching of the present invention. In embodiments, single tube and multi-tube flowmeters having one or more drivers and pickoffs are contemplated.

The meter electronics 20 in one embodiment is configured to vibrate the flow conduit 103A and 103B. The vibration is performed by the driver 104. The meter electronics 20 further receives resulting vibrational signals from the pickoff sensors 105 and 105′. The vibrational signals comprise a vibrational response of the flow conduits 103A and 103B. The meter electronics 20 processes the vibrational response and determines a response frequency and/or phase difference. The meter electronics 20 processes the vibrational response and determines one or more flow measurements, including a mass flow rate and/or density of the process fluid. Other vibrational response characteristics and/or flow measurements are contemplated and are within the scope of the description and claims.

In one embodiment, the flow conduits 103A and 103B comprise substantially omega-shaped flow conduits, as shown. Alternatively, in other embodiments, the flowmeter can comprise substantially straight flow conduits, U-shaped conduits, delta-shaped conduits, etc. Additional flowmeter shapes and/or configurations can be used and are within the scope of the description and claims.

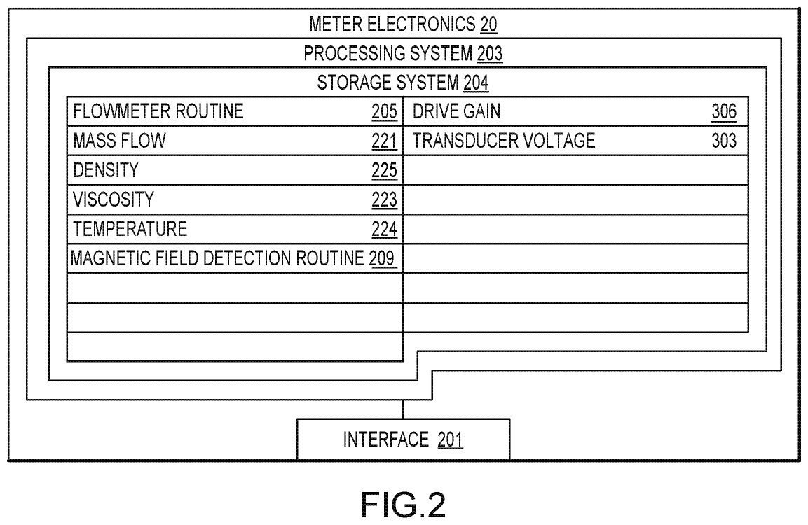

FIG. 2 is a block diagram of the meter electronics 20 of a flowmeter 5 according to an embodiment. In operation, the flowmeter 5 provides various measurement values that may be outputted including one or more of a measured or averaged value of mass flow rate, volume flow rate, individual flow component mass and volume flow rates, and total flow rate, including, for example, both volume and mass flow.

The flowmeter 5 generates a vibrational response. The vibrational response is received and processed by the meter electronics 20 to generate one or more fluid measurement values. The values can be monitored, recorded, saved, totaled, and/or output.

The meter electronics 20 includes an interface 201, a processing system 203 in communication with the interface 201, and a storage system 204 in communication with the processing system 203. Although these components are shown as distinct blocks, it should be understood that the meter electronics 20 can be comprised of various combinations of integrated and/or discrete components.

The interface 201 is configured to communicate with the sensor assembly 10 of the flowmeter 5. The interface 201 may be configured to couple to the leads 100 (see FIG. 1) and exchange signals with the driver 104, pickoff sensors 105 and 105′, and temperature sensors (not shown), for example. The interface 201 may be further configured to communicate over the communication path 26, such as to external devices.

The processing system 203 can comprise any manner of processing system. The processing system 203 is configured to retrieve and execute stored routines in order to operate the flowmeter 5. The storage system 204 can store routines including a flowmeter routine 205, and a magnetic field detection routine 209. Other measurement/processing routines are contemplated and are within the scope of the description and claims. The storage system 204 can store measurements, received values, working values, and other information. In some embodiments, the storage system stores a mass flow (m) 221, a density (p) 225, a viscosity (u) 223, a temperature (T) 224, a drive gain 306, a transducer voltage 303, and any other variables known in the art. The drive gain 306 comprises a relative measurement of how much power is being consumed by the driver to keep the conduits vibrating at a desired frequency.

The flowmeter routine 205 can produce and store fluid quantifications and flow measurements. These values can comprise substantially instantaneous measurement values or can comprise totalized or accumulated values. For example, the flowmeter routine 205 can generate mass flow measurements and store them in the mass flow 221 storage of the storage system 204, for example. The flowmeter routine 205 can generate density 225 measurements and store them in the density 225 storage, for example. The mass flow 221 and density 225 values are determined from the vibrational response, as previously discussed and as known in the art. The mass flow and other measurements can comprise a substantially instantaneous value, can comprise a sample, can comprise an averaged value over a time interval, or can comprise an accumulated value over a time interval. The time interval may be chosen to correspond to a block of time during which certain fluid conditions are detected, for example a liquid-only fluid state, or alternatively, a fluid state including liquids and entrained gas. In addition, other mass flow and related quantifications are contemplated and are within the scope of the description and claims.

By placing an external magnet close to the pickoff of a Coriolis meter, the flow reading can be changed either indicating more flow or less flow depending on the external magnet's pole position or the external magnet's location on the meter, inlet or outlet.

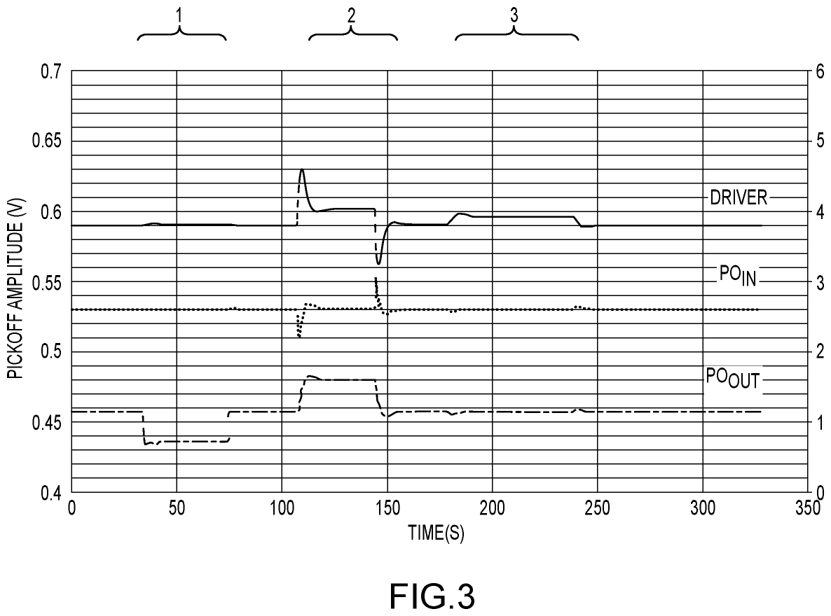

Turning to FIG. 3, it is shown that by monitoring meter electronics 20, external magnetic fields, whether from electromagnetic sources or permanent magnets, affect the reading of the sensor assembly 10 when magnets and coils are utilized for the pick-off sensors 105 and 105′. It is evident that relatively sharp and symmetrical step changes are present.

The region noted by Bracket #1 in FIG. 3 represents a magnet being placed proximate the pick-off sensor 105′ located closest to the flowmeter's output. When a magnet is placed there, a relatively sharp and symmetrical step change in voltage is detected in the signal provided by the pick-off sensor 105′ located closest to the flowmeter's output (labeled PO_{OUT} in FIG. 3).

The region noted by Bracket #2 in FIG. 3 represents a magnet being placed proximate the pick-off sensor 105 located closest to the flowmeter's input. When a magnet is placed there, a relatively sharp and symmetrical step change in voltage is also detected in the signal provided by the pick-off sensor 105′ located closest to the flowmeter's output (labeled PO_{OUT} in FIG. 3). Voltage spikes are also detected in the signal provided by the pick-off sensor 105 located closest to the flowmeter's input (labeled PO_{IN} in FIG. 3). Voltage spikes are also detected in the signal provided by the driver 104.

The region noted by Bracket #3 in FIG. 3 represents a magnet being placed proximate the driver 104. A detectable and relatively sharp and symmetrical step change in voltage is detected in the signal provided by the driver 104.

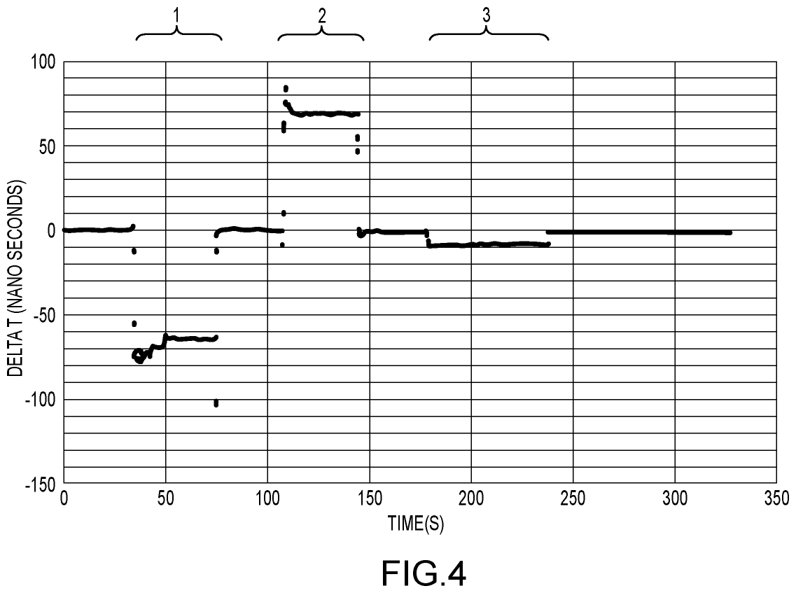

Turning to FIG. 4, it is shown that external magnets affect the ΔT readings of the flowmeter 5. When the driver 104 stimulates the flow conduits 103A, 103B to oscillate in opposition at the natural resonant frequency, the flow conduits 103A, 103B oscillate, and the voltage generated from each pick-off sensor 105, 105′ generates a sine wave. This indicates the motion of one conduit relative to the other. The time delay between the two sine waves is referred to as the ΔT, which is directly proportional to the mass flow rate. If the phase of either of the flow conduits 103A, 103B is affected, ΔT changes. Flow should cause a positive change in one pick-off sensor's phase and an equal negative change in the other pick-off sensor's phase.

The region noted by Bracket #1 in FIG. 4 represents a magnet being placed proximate the pick-off sensor 105′ located closest to the flowmeter's output. When a magnet is placed there, a relatively sharp and symmetrical stepped decrease in ΔT is detected.

The region noted by Bracket #2 in FIG. 4 represents a magnet being placed proximate the pick-off sensor 105 located closest to the flowmeter's input. When a magnet is placed there, a relatively sharp and symmetrical stepped increase in ΔT is detected.

The region noted by Bracket #3 in FIG. 4 represents a magnet being placed proximate the driver 104. When a magnet is placed there, a relatively sharp and symmetrical stepped decrease in ΔT is detected.

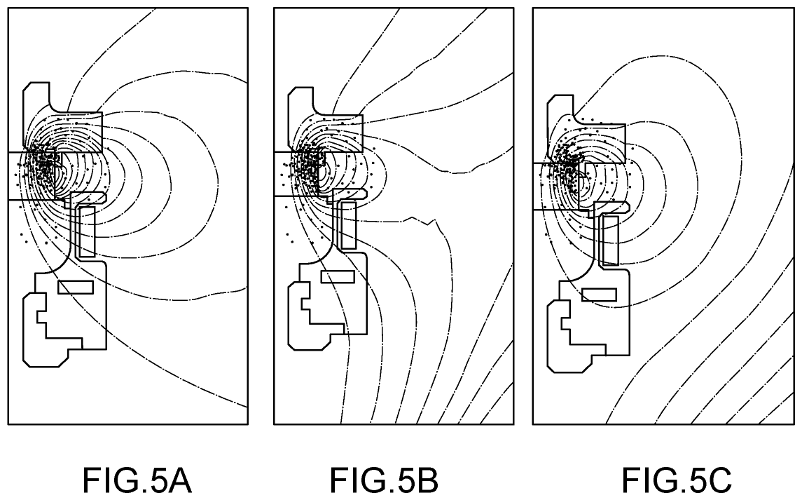

FIGS. 5A-5C illustrate how the magnetic field proximate a transducer changes in the presence of another magnet. FIG. 5A illustrates the magnetic fields (dashed lines) of a pickoff assembly with no magnet present. FIG. 5B illustrates magnetic fields when an external magnet is present with the magnet's south pole oriented towards the pickoff assembly, and FIG. 5C illustrates magnetic fields when an external magnet is present with the magnet's north pole oriented towards the pickoff assembly. If the magnetic field is disturbed or changes during the meter's operation the meter's output will be affected, as shown in FIG. 4.

In an embodiment, an approach for detecting magnetic tampering would be to monitor pickoff voltage. In an embodiment, the voltage difference between the pickoff sensors 105 and 105′ is measured. In an embodiment, the voltage ratio between the pickoff sensors 105 and 105′ is measured.

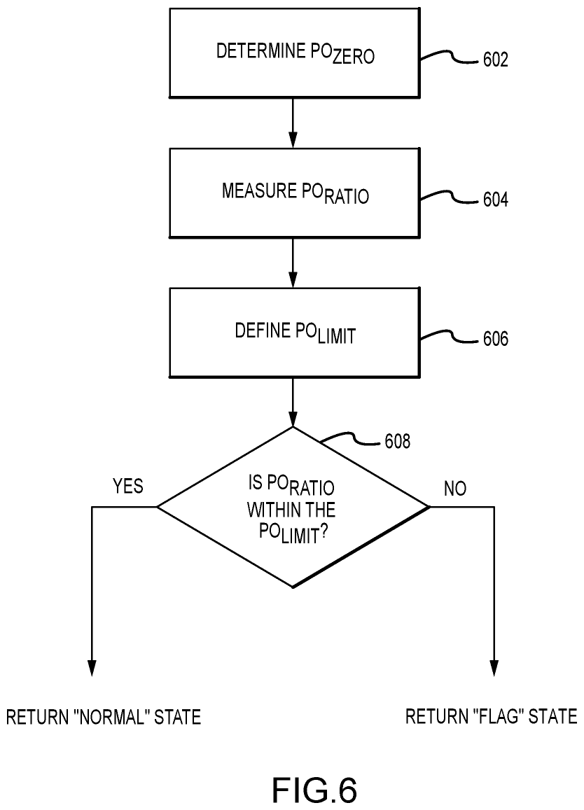

In the description below, the pickoff ratio is discussed. However, it is contemplated that the pickoff difference can be used as well. The pickoff sensors 105 and 105′ will also be referred to as LPO (left pickoff) and RPO (right pickoff), respectively. A flow chart is provided as FIG. 6, which illustrates a method for determining magnetic tampering. In embodiments, a PO_{ZERO} is determined, as shown in step 602. The PO_{ZERO} refers to the average values captured during a zeroing process:

$${PO}_{ZERO} = \frac{{RPO}_{ZERO}}{{LPO}_{ZERO}} Where : \\ {RPO}_{ZERO} = the average values captured during a zeroing process for the RPO {LPO}_{ZERO} = the average values captured during a zeroing process for the LPO \qquad ( 1 )$$

The zeroing process is generally conducted when there is no flow through the flow meter, and the driving force applied to the conduits causes all points along the conduits to oscillate with the same phase or a small “zero offset,” which is the time delay measured at zero flow. The process allows the flowmeter to be calibrated such that no flow is measured during no-flow states.

In embodiments, a PO_{RATIO} is measured, as shown in step 604, which is the pickoff voltage ratio captured during fluid flow and meter operation.

$${PO}_{RATIO} = \frac{RPO}{LPO} \\ RPO = Voltage values captured during meter operation for the RPO LPO = Voltage values captured during meter operation for the LPO \qquad ( 2 )$$

In embodiments, a PO_{LIMIT} is established, as shown in step 606. The PO_{LIMIT} is the pickoff ratio limit, which is the deviation of the PO_{RATIO} from the PO_{ZERO} that is allowable before tampering is indicated. Since there are many types of flowmeter construction, operation settings, installation variables, flow variables, and process variables, the PO_{LIMIT} will vary from application to application, as will be understood by those skilled in the art.

The PO_{RATIO} is compared with the PO_{LIMIT} in step 608. If the PO_{RATIO} is within the PO_{LIMIT} it is determined that the flowmeter is operating withing “normal” operation limits. However, if the PO_{RATIO} is outside of the PO_{LIMIT} a flag is generated which indicates potential magnetic tampering.

This approach may, under certain flow conditions, provide a flag indicating tampering, despite the fact that there was no tampering. In embodiments, in order to limit the number of “False Flags,” additional logic is added which involves monitoring additional meter outputs. These outputs may include one or more of Mass Flow, Density, and Drive Gain.

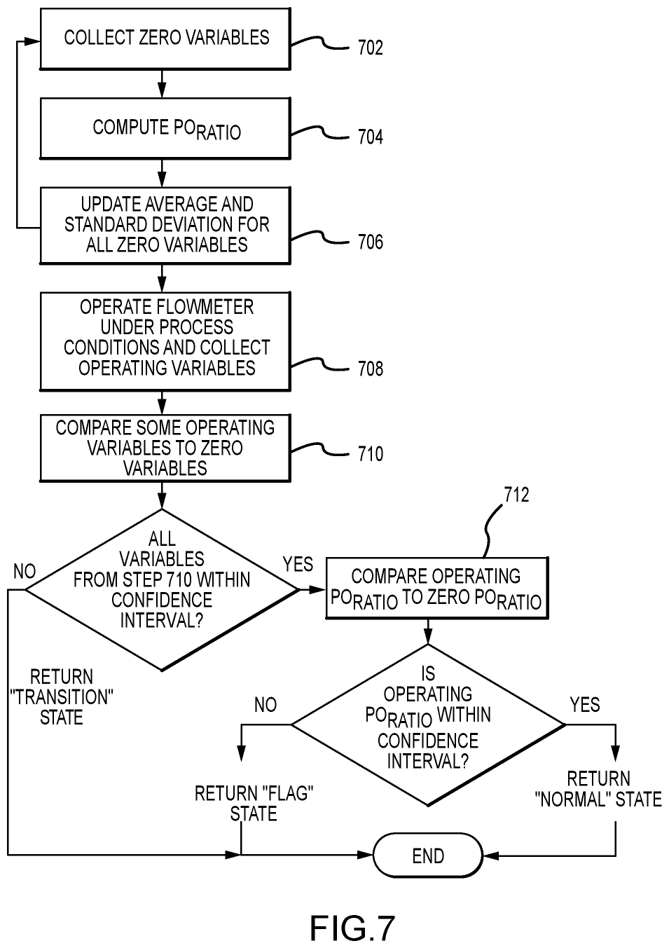

A flow chart that illustrates additional checks to reduce false flags is illustrated in FIG. 7. In this embodiment, a number of system states may be returned: “Normal”, “Flag”, and “Transition.” A normal state implies that all pilot variables and the pickoff ratio are within their confidence intervals. A flag state implies that all pilot variables are within their confidence intervals, but the pickoff ratio has exited its confidence interval. A transition state implies that at least one pilot variable has exited its confidence interval. Each of these system states can be stored simply as numerical codes and read back as such via modbus communication, for example. Numerical codes may be translated into text for human readability and may be presented to a display.

In step 702, a plurality of zero variables is collected. The zero variables may include RPO and LPO signals, flow tube frequency, drive gain, fluid density, damping factors, and other flowmeter variables known in the art.

In step 704, the pickoff voltage ratio, PO_{RATIO}, captured during fluid flow and meter operation is computed according to Equation (1). In step 706, the zero variables collected over time, including the pickoff voltage ratio, are averaged and/or the standard deviation is computed. A suitable data structure, such as an array, is used to store the average and standard deviation of each variable in the storage system 204.

Steps 702 to 706 are iterated during the zero process or under zeroing conditions. This aids in creating a baseline for all the collected variables that may be set for comparison purposes during process conditions. These values may be set at the factory during manufacturing and calibration, or may be set/reset in the field (i.e. post-installation) under zeroing conditions.

In step 708, the flowmeter is operated under process conditions, and operating variables are collected. The operating variables are from the same set of variables as collected during the zero process, but instead are collected under process conditions. The operating variables may include RPO and LPO signals, flow tube frequency, drive gain, fluid density, damping factors, and other flowmeter variables known in the art. These operating variables are collected over time and are averaged and/or the standard deviation is computed. An operating PO_{RATIO} is also calculated. A suitable data structure, such as an array, is used to store the average and standard deviation of RPO and LPO signals and PO_{RATIO} in the storage system 204.

In step 710, some of the operating variables are compared to zero variables. In particular, the flow tube frequency, drive gain, fluid density, and/or damping factors are compared, and it is determined whether all of the compared values are within a confidence interval.

The confidence interval may be determined empirically, based upon targeting a desired outcome, as will be understood by those skilled in the art. In an embodiment, the confidence interval (CI) for a particular variable of interest (Vᵢ) comprises:

$$CI = 2 * {StdDev}_{{V}_{i}} + deadband * {Avg}_{{V}_{i}} \\ Where : \\ {StdDev}_{{V}_{i}} = Standard deviation of the variable of interest \\ deadband = factor to buffer observable response \\ {Avg}_{{V}_{i}} = Measured average of the variable of interest \qquad ( 3 )$$

The deadband is determined empirically so to adjust the sensitivity of the system.

If any of the variables are outside of their respective confidence intervals, a “transition” flag state is activated. However, if all of the variables are within their respective confidence intervals, then the PO_{RATIO} is compared in step 712. In particular, in step 712, the operating PO_{RATIO} is compared to the previously-determined zero PO_{RATIO} from steps 702-704. If the operating PO_{RATIO} is within its confidence interval, a “normal” state is returned. If, however, the operating PO_{RATIO} is outside of its confidence interval, a “flag” state is returned, indicating a potential magnetic tampering event.

It should be noted that if no zero values are stored, the flow chart of FIG. 7 may begin at step 708. In this case, instead of zero values, reference values are substituted for comparison. The reference values are estimated values that are saved in memory that approximate ideal zero values. These values will differ based upon flowmeter particulars such as geometry, size, construction materials, transducer arrangements and types, etc. One or more zero variables may be substituted for a reference value in an embodiment.

Turning back to step 712, the following is an example of how this flow chart may be arranged in an embodiment. Pseudocode is provided merely as an aid utilized for clarity, and should not be construed as limiting:

### A First Step May be to Check Density Variation Using a Density Ratio:

$${\overline{ρ}}_{r} = ( \frac{{ρ}_{m}}{{ρ}_{zero}} ) Where : \\ {ρ}_{m} = Measured density {\overline{ρ}}_{r} = Average density ratio {ρ}_{z e r o} = Density reference value \qquad ( 4 )$$

### With the Density Ratio Established, an Example of the Following Logic May be Applied:

```
If ρ̅ᵣ <= (1−ρₗ) then
  Check state = “Transition”
Else if ρ̅ᵣ <= (1+ρₗ) then
  Check state = “Transition”
Else
  Check state = “Normal”
Where: ρₗ = Density range limit
```

Another output check may be Drive Gain variation using the Drive Gain Ratio:

$${Dg}_{r} = ( \frac{{Dg}_{m}}{{Dg}_{zero}} ) Where : \\ {Dg}_{m} = Measured drive gain {Dg}_{r} = Average drive gain ratio {Dg}_{zero} = Drive gain reference value \qquad ( 5 )$$

With the Drive Gain Ratio established, an example of the following logic may be applied:

```
If Dgₘ = 100 then
  Check state = “Transition”
Else if Dgᵣ <= (1−Dgₗ) then
  Check state = “Transition”
Else if Dgᵣ <= (1+Dgₗ) then
  Check state = “Transition”
Else
  Check state = “Normal”
Where: Dgₗ = Drive gain range limit
```

Lastly, the Pickoff Ratio logic is applied, as noted in Equation (2). The Pickoff Ratio Logic may be illustrated as:

```
If POᵣ < (PO_{zero} − POₗᵢₘᵢₜ) then
  Check state = “Flag”
If POᵣ < (PO_{zero} + POₗᵢₘᵢₜ) then
  Check state = “Flag”
Else
  Check state = “Normal”
Where: POₗᵢₘᵢₜ = PO range limit
```

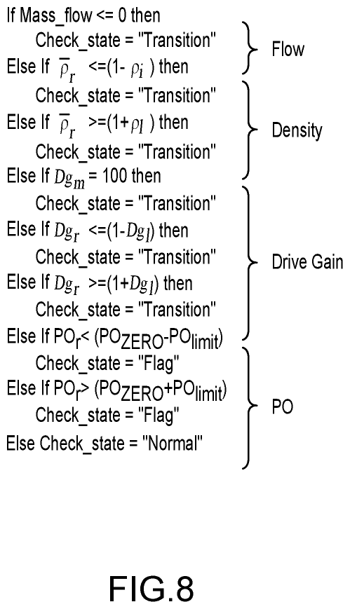

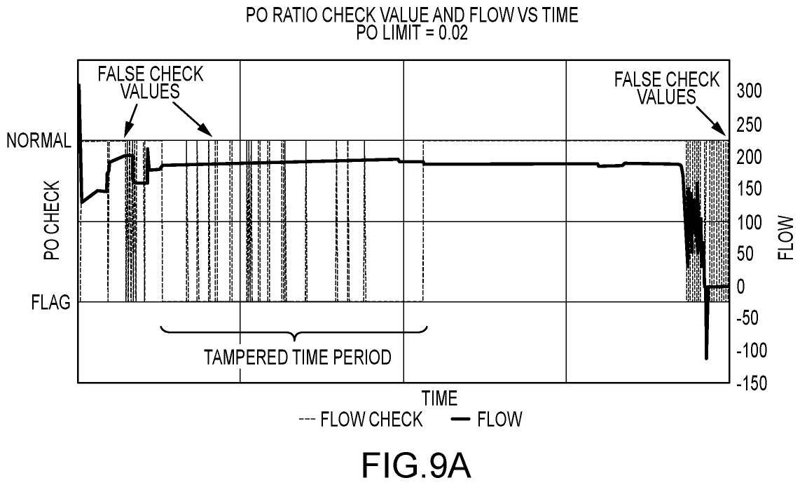

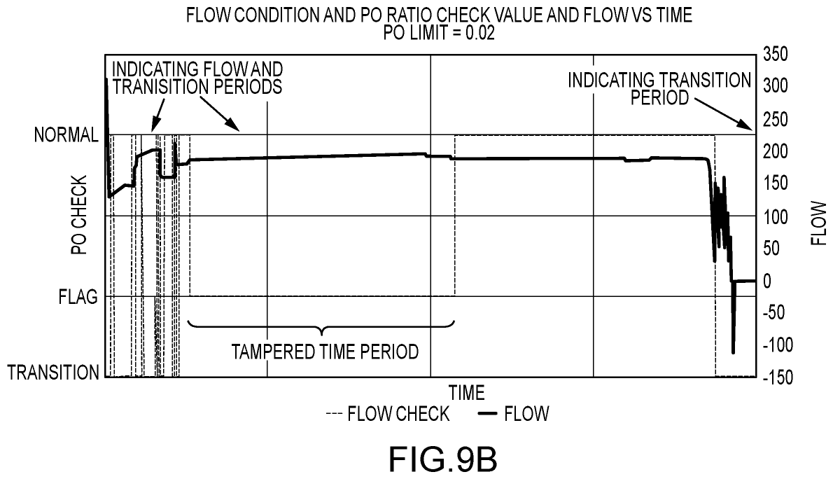

An example of the combined logic, illustrated using pseudocode, is found in FIG. 8. It should be noted that the flow, density and drive gain variables may or may not be present in embodiments, and the order in which they are analyzed may differ. Referring to FIG. 9B, applying the above flow condition logic to the PO ratio data from FIG. 9A, it will be clear that there are significantly fewer false check values (“False Flags”) than just using the pickoff ratio alone for a predetermined PO limit.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other sensors, sensor brackets, and conduits and not just to the embodiments described above and shown in the accompanying figures. Accordingly, the scope of the embodiments described above should be determined from the following claims.

What is claimed is:

1. A Coriolis flowmeter (5), comprising:
flow conduits (103A, 103B);
a driver (104) and pick-off sensors (LP0,105; RPO,105′) connected to the flow conduits (103A and 103B);
a meter electronics (20) configured to drive the driver (104) to oscillate the flow conduits (103A, 103B), and to receive signals from the pick-off sensors (105, 105′);
wherein the meter electronics (20) is configured to capture voltages for both the pick-off sensors (105, 105′) and determine a PO_{RATIO};
wherein the meter electronics (20) is configured determine whether the PO_{RATIO} falls within a predetermined POLMIT; and
wherein the meter electronics (20) is configured to indicate a presence of an external magnetic field if the PO_{RATIO} falls outside the predetermined PO_{LIMIT}.

2. The Coriolis flowmeter (5) of claim 1, wherein a first process variable is collected and compared to a first confidence interval; and
wherein the meter electronics (20) is configured to indicate a presence of an external magnetic field if the first process variable falls within the first confidence interval and the PO_{RATIO} falls outside a predetermined PO_{LIMIT}.

3. The Coriolis flowmeter (5) of claim 2, wherein a second process variable is collected and compared to a second confidence interval; and
wherein the meter electronics (20) is configured to indicate a presence of an external magnetic field if both the first and second process variables fall within their respective confidence intervals and the PO_{RATIO} falls outside a predetermined PO_{LIMIT}.

4. The Coriolis flowmeter (5) of claim 3, wherein a third process variable is collected and compared to a third confidence interval; and
wherein the meter electronics (20) is configured to indicate a presence of an external magnetic field if the first, second and third process variables fall within their respective confidence intervals and the PO_{RATIO} falls outside a predetermined PO_{LIMIT}.

5. The Coriolis flowmeter (5) of claim 4, wherein the first, second, and third process variables each comprise one of a flow tube frequency, drive gain, fluid density, and damping factor.

6. The Coriolis flowmeter (5) of claim 1, wherein a PO_{ZERO} is collected by the meter electronics (20), and at least one of an average and standard deviation are determined for the PO_{ZERO} by the meter electronics (20); and
wherein the meter electronics (20) is configured to determine the PO_{LIMIT} as comprising a permissible deviation from the PO_{ZERO}.

7. The Coriolis flowmeter (5) of claim 4, wherein the meter electronics returns a “transition” state if any of the first, second, and third process variables are outside their respective confidence intervals.

8. The Coriolis flowmeter (5) of claim 4, wherein the meter electronics returns a “normal” state if all of the first, second, and third process variables are within their respective confidence intervals and the PO_{RATIO} falls within the predetermined PO_{LIMIT}.

9. A method for operating a Coriolis flowmeter comprising:
flowing a flow material through flow conduits of the flowmeter;
driving a driver connected to the flow conduits to oscillate the flow conduits in a first bending mode;
receiving signals from pick-off sensors connected to the flow conduits;
capturing voltages for the pick-off sensors and determining a PO_{RATIO};
determining whether the PO_{RATIO} falls within a predetermined PO_{LIMIT}; and
indicating a presence of an external magnetic field if the PO_{RATIO} falls outside the predetermined PO_{LIMIT}.

10. The method for operating a Coriolis flowmeter of claim 9, comprising:
collecting a first process variable;
comparing the first process variable to a first confidence interval; and
indicating a presence of an external magnetic field if the first process variable falls within the first confidence interval and the PO_{RATIO} falls outside a predetermined PO_{LIMIT}.

11. The method for operating a Coriolis flowmeter of claim 10, comprising:
collecting a second process variable;
comparing the second process variable to a second confidence interval, and
wherein the meter electronics (20) is configured to indicate a presence of an external magnetic field if both the first and second process variables fall within their respective confidence intervals and the PO_{RATIO} falls outside a predetermined PO_{LIMIT}.

12. The method for operating a Coriolis flowmeter of claim 10, comprising:
collecting a third process variable;
comparing the third process variable to a third confidence interval, and
wherein the meter electronics (20) is configured to indicate a presence of an external magnetic field if both the first and third process variables fall within their respective confidence intervals and the PO_{RATIO} falls outside a predetermined PO_{LIMIT}.

13. The method for operating a Coriolis flowmeter of claim 12, wherein the first, second, and third process variables each comprise one of a flow tube frequency, drive gain, fluid density, and damping factor.

14. The method for operating a Coriolis flowmeter of claim 9, comprising:
collecting a PO_{ZERO};
determining at least one of an average and standard deviation for the PO_{ZERO}; and
determining the PO_{LIMIT} that comprises a permissible deviation from the PO_{ZERO}.

15. The method for operating a Coriolis flowmeter of claim 12, comprising returning a “transition” state if any of the first, second, and third process variables are outside their respective confidence intervals.

16. The method for operating a Coriolis flowmeter of claim 12, comprising returning a “normal” state if all of the first, second, and third process variables are within their respective confidence intervals and the PO_{RATIO} falls within the predetermined PO_{LIMIT}.
